(19) United States
(12) Patent Application Publication
(10) Pub. No.: US 2026/0177185 A1
(43) Pub. Date: Jun. 25, 2026

(54) Pipe End Cover Device

(71) Applicant: Edward Sanchez, Santa Rosa, CA (US)

(72) Inventor: Edward Sanchez, Santa Rosa, CA (US)

(21) Appl. No.: 19/308,412

(22) Filed: Aug. 25, 2025

Related U.S. Application Data
(60) Provisional application No. 63/738,752, filed on Dec. 24, 2024.

(51) Int. Cl. F16L 57/00

(52) U.S. Cl. CPC F16L 57/005

(57) ABSTRACT

A pipe end cover device is provided. The device is comprised of a protective cap configured to fit over exposed ends of conduit or piping during construction or utility installation. The device comprises a body made from flexible and resilient materials such as neoprene, silicone, thermoplastic elastomer, canvas, or coated textile that enable elastic deformation to accommodate pipes of varied diameters. Embodiments of the device comprise additional features including longitudinal or radial slits to permit expansion, drawstrings routed through peripheral inlets for cinching, and strap-based retention systems secured via mechanical fasteners such as hook-and-loop closures or cam buckles. Some embodiments further comprise a molded or attached tab bearing indicia such as utility codes, icons, or color markings for identification, and grip textures to facilitate handling. The external surface of the body may be color-coded to correspond with standardized utility identifiers, such as red for electrical and blue for potable water.

### CROSS-REFERENCE TO RELATED APPLICATION

The present application claims priority to, and the benefit of, U.S. Provisional Application No. 63/738,752, which was filed on Dec. 24, 2024, and is incorporated herein by reference in its entirety.

### FIELD OF THE INVENTION

The present invention relates generally to the field of pipes. More specifically, the present invention relates to a protective cap configured to fit over exposed ends of conduit or piping during construction or utility installation. Accordingly, the present disclosure makes specific reference thereto. Nonetheless, it is to be appreciated that aspects of the present invention are also equally applicable to other like applications, devices, and methods of manufacture.

### BACKGROUND

During construction and utility installation, exposed pipe and conduit ends present multiple challenges that can negatively impact both the progress and safety of ongoing operations. These open ends are susceptible to the ingress of dust, debris, moisture, and other foreign materials, which can result in contamination, clogging, or subsequent malfunction of utility lines. Traditional methods for sealing pipe ends often involve rigid caps or improvised covers, many of which require precise dimensional matching and do not adapt well to variable diameters or environmental stressors. Furthermore, rigid or inflexible solutions can introduce safety risks due to sharp edges, poor impact resistance, and the necessity for tools during installation or removal. These solutions also often lack any means for clear visual identification, leading to confusion or errors in complex utility environments where multiple services are laid in parallel. Identifying the type of utility a pipe supports is critical for safe handling, inspection, and coordination among trades. In addition, repeated installation and removal cycles are common in construction phases, necessitating a solution that supports reusability without material degradation or performance loss. A more adaptable, safe, and clearly identifiable solution is required to protect conduit and piping ends effectively in diverse and demanding work environments.

Therefore, there exists a long-felt need in the art for a pipe end cover device that prevents debris, moisture, and foreign object intrusion into open conduit or piping. There also exists a long-felt need in the art for a pipe end cover device that facilitates tool-free, rapid application and removal across varying pipe diameters. Moreover, there exists a long-felt need in the art for a pipe end cover device that provides immediate visual identification of the pipe's utility type through standardized markings or color codes.

The subject matter disclosed and claimed herein, in one embodiment thereof, comprises a pipe end cover device. The device is comprised of a protective cap configured to fit over exposed ends of conduit or piping during construction or utility installation. The device comprises a body made from flexible and resilient materials such as neoprene, silicone, thermoplastic elastomer, canvas, or coated textile that enable elastic deformation to accommodate pipes of varied diameters. Embodiments of the device comprise additional features including longitudinal or radial slits to permit expansion, drawstrings routed through peripheral inlets for cinching, and strap-based retention systems secured via mechanical fasteners such as hook-and-loop closures or cam buckles. Some embodiments further comprise a molded or attached tab bearing indicia such as utility codes, icons, or color markings for identification, and grip textures to facilitate handling. The external surface of the body may be color-coded to correspond with standardized utility identifiers, such as red for electrical and blue for potable water.

In this manner, the pipe end cover device of the present invention accomplishes all the forgoing objectives and provides a device that prevents the ingress of contaminants into open piping, enabling quick and secure application without specialized tools, and providing standardized visual identification of utility types. The combination of flexible material construction, expandable geometry, and integrated fastening mechanisms allows the device to adapt to a wide range of pipe diameters while maintaining a secure and reusable fit. Furthermore, the incorporation of labeled tabs and color-coded surfaces directly addresses the need for accurate utility identification, enhancing safety and workflow efficiency. As a result, the pipe end cover device resolves the limitations of conventional rigid caps and improvised covers, offering a robust and practical solution for protecting conduit and piping during construction operations

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pipe end cover device. The device is a pipe cover configured to protect exposed pipe ends during construction and utility installation by preventing the intrusion of debris, moisture, and foreign objects while providing visual identification of utility type. The device offers an alternative to rigid caps by eliminating the need for precise size matching and reducing the risk of injury from sharp or inflexible edges. The device supports rapid, tool-free application and removal, enabling repeated reuse. The construction includes flexible, resilient materials that expand to fit various pipe diameters and absorb impact energy to reduce injury risk during handling or accidental drops.

Various embodiments of the device are comprised of flexible, elastomeric bodies formed to accommodate a range of pipe diameters through elastic deformation. A first embodiment includes a monolithic cylindrical body and top, formed from materials such as neoprene, silicone, TPE, or rubber, with an open lower end that stretches over pipe ends. The construction is optimized for rapid installation and removal in standard construction environments.

A second embodiment includes a cylindrical fabric body and top, with an open end featuring at least one longitudinal slit for expansion and a drawstring inlet for securing the cover around pipes. Water-resistant or flame-retardant textiles such as Nylon or canvas enhance durability in rugged environments. An optional configuration includes a cord lock for retaining the drawstring under vibration or movement.

A third embodiment features a cylindrical body and top formed from reinforced textiles. The open end includes at least one expansion slit and a dual-strap system with complementary fasteners that secure the cover under mechanical stresses. The fasteners enable precise tension control and reusability.

A fourth embodiment includes a body, a circular top, and an open end with at least one tab extending from the top. The tab features indicia for utility identification and a grip texture to facilitate manual removal.

A fifth embodiment includes a body and top constructed from flexible materials such as Neoprene or vinyl-laminated fabric. The open end includes at least one radial slit and a retention strap affixed near the end. The strap is secured using complementary fasteners on the strap and body, ensuring robust retention and tool-free release.

All embodiments may include color-coded bodies aligned with standardized utility markings. The coloration may be applied through various means, including pigmentation, overprinting, woven threads, or coatings. The device may be manufactured in standard sizes to fit commonly used conduit diameters, with an internal diameter slightly undersized to ensure a secure fit. All embodiments maintain dimensional flexibility to accommodate a range of utility installation contexts.

Accordingly, the pipe end cover device of the present invention is particularly advantageous as it prevents the ingress of contaminants into open piping, enabling quick and secure application without specialized tools, and providing standardized visual identification of utility types. The combination of flexible material construction, expandable geometry, and integrated fastening mechanisms allows the device to adapt to a wide range of pipe diameters while maintaining a secure and reusable fit. Furthermore, the incorporation of labeled tabs and color-coded surfaces directly addresses the need for accurate utility identification, enhancing safety and workflow efficiency. As a result, the pipe end cover device resolves the limitations of conventional rigid caps and improvised covers, offering a robust and practical solution for protecting conduit and piping during construction operations. In this manner, the pipe end cover device overcomes the limitations of existing pipe covers known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a first potential embodiment of a pipe end cover device of the present invention in accordance with the disclosed architecture;

FIG. 2A illustrates a perspective view of a second potential embodiment of a pipe end cover device of the present invention in accordance with the disclosed architecture;

FIG. 2B illustrates a perspective view of a third potential embodiment of a pipe end cover device of the present invention in accordance with the disclosed architecture;

FIG. 3 illustrates a perspective view of a fourth potential embodiment of a pipe end cover device of the present invention with the strap unattached in accordance with the disclosed architecture;

FIG. 4 illustrates a perspective view of a fifth potential embodiment of a pipe end cover device of the present invention in accordance with the disclosed architecture; and

FIG. 5 illustrates a perspective view of a sixth potential embodiment of a pipe end cover device of the present invention with the strap unattached to the body in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a pipe end cover device that prevents debris, moisture, and foreign object intrusion into open conduit or piping. There also exists a long-felt need in the art for a pipe end cover device that facilitates tool-free, rapid application and removal across varying pipe diameters. Moreover, there exists a long-felt need in the art for a pipe end cover device that provides immediate visual identification of the pipe's utility type through standardized markings or color codes.

The present invention, in one exemplary embodiment, is comprised of a pipe end cover device. The pipe cover device serves to shield exposed pipe ends during construction and utility installation by blocking the entry of debris, moisture, and foreign materials. Additionally, the device provides visible utility type identification. Unlike rigid caps, the device does not require precise size matching and minimizes injury risks associated with sharp or inflexible edges.

The device is designed for quick application and removal without tools, the device is reusable across multiple installation cycles. The use of flexible, resilient materials enables adaptation to various pipe diameters while also absorbing impact energy to enhance safety during handling or accidental drops.

The device body elastically deforms over a range of pipe diameters characterize various embodiments of the device. One embodiment features a monolithic cylindrical body and top, constructed from materials such as neoprene, silicone, TPE, or rubber. This configuration includes an open lower end capable of stretching over pipe ends and is suited for rapid deployment in typical construction settings.

Another embodiment utilizes a cylindrical fabric body and top, incorporating at least one longitudinal slit at the open end for radial expansion. A drawstring inlet surrounds the opening, allowing the cover to be tightened around pipes. Textiles such as Nylon or canvas, optionally treated for water or flame resistance, enhance durability. A cord lock may be included for secure retention of the drawstring under dynamic conditions.

A third configuration comprises a cylindrical body and top made from reinforced textiles. At least one expansion slit is provided at the open end, along with a dual-strap system incorporating fasteners that engage under tension. This arrangement ensures a secure attachment during mechanical stresses and supports adjustability and reuse.

In a fourth embodiment, the body includes a circular top and an open end, with at least one tab projecting from the top surface. The tab incorporates indicia for utility identification and a grip texture to aid in manual removal.

A fifth embodiment employs materials such as Neoprene or vinyl-laminated fabric in the construction of the body and top. The open end features at least one radial slit for circumferential flexibility and a retention strap affixed near the opening. Fasteners positioned on both the strap and the body permit the strap to encircle and secure the cover, allowing for tool-free release under varied conditions.

Each embodiment may feature color-coded bodies in accordance with standardized utility markings, applied through pigmentation, coatings, overprinting, or woven thread integration. The device may be produced in standard sizes suited to common conduit diameters, with an intentionally undersized internal diameter to ensure a secure fit. Dimensional adaptability is preserved across all embodiments to support diverse installation environments.

Therefore, the disclosed pipe end cover device effectively blocks contaminants from entering open piping, allows for rapid and secure application without the need for tools, and provides consistent utility identification. The flexible structure, expandable form, and integrated fastening components support compatibility with various pipe sizes while ensuring secure reuse. Labeled tabs and color-coded surfaces address utility classification requirements, improving both safety and operational efficiency. As such, the device offers a practical and durable alternative to conventional rigid caps and makeshift solutions, resolving the shortcomings of existing pipe cover technologies.

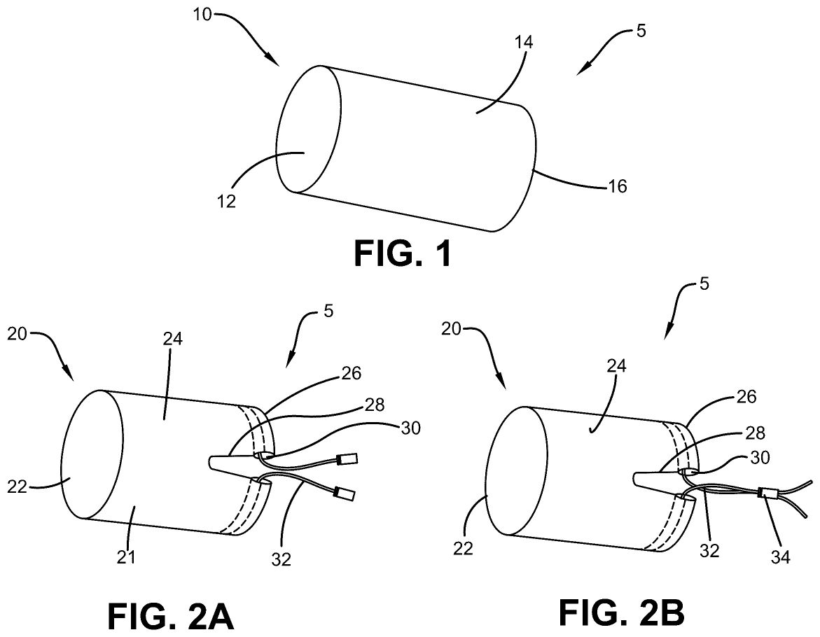

Referring initially to the drawings, FIG. 1 illustrates a perspective view of a first potential embodiment 10 of a pipe end cover device 5 of the present invention in accordance with the disclosed architecture. The device 5 is a pipe cover configured to protect exposed pipe ends during construction and utility installation. More specifically, the primary function of the device 5 may be to prevent the intrusion of debris, moisture, and foreign objects into open conduit or piping while concurrently providing clear visual identification of the utility type associated with the covered pipe. The device 5 may be particularly advantageous in environments where rigid, hard-sided caps are unsuitable due to their requirement for precise size matching, lack of adaptability, and elevated risk of injury from sharp or inflexible edges.

The device 5 further supports rapid, tool-free application and removal, accommodating repeated cycles of use, and offering enhanced protection from debris ingress, moisture exposure, and mechanical impact. The structure of the device 5 may incorporate flexible and resilient materials that enable expansion over varied pipe diameters while also absorbing energy from physical contact, thereby minimizing the risk of injury during incidental handling or accidental drops.

In various embodiments 10,20,30,50,60, the device 5 may be comprised of a flexible, elastomeric body 14, 24, 34, 54, 64, which may be formed to accommodate a range of pipe diameters through elastic deformation.

As depicted in FIG. 1, a first embodiment 10 of the device 5 is shown. This embodiment 10 includes a body 14 with a top 12, wherein the body 14 and top 12 may be integrally formed or securely bonded. In other embodiments, the body 14 may have a multi-piece construction. The body 14 may have a generally cylindrical geometric shape with a closed top end and an open lower end 16, which may be dimensioned to stretch over and snugly grip the exposed end of conduit or piping. However, the shape of the body 14 and/or top 12 may vary in any embodiment. The flexible construction of this embodiment 10 may include materials such as, but not limited to, neoprene, silicone, TPE, or rubber compounds. This embodiment 10 may be suited for standard construction environments requiring rapid installation and removal, and its monolithic design may minimize seams or failure points that could otherwise collect debris.

As shown in FIG. 2A, a second embodiment 20 may include a body 24 with a top 22 and an open end 26, all forming a generally cylindrical geometry. The flexible material for this embodiment 20 may include textiles such as, but not limited to, Nylon, canvas, or coated polyester, which may be treated with water-resistant or flame-retardant coatings 21. The fabric-based construction of this embodiment 20 may enhance puncture resistance and resilience in rugged environments such as utility trenches or industrial zones.

The end 26 of the second embodiment 20 may include at least one longitudinal slit 28 to permit radial expansion or contraction, thus enhancing fit across variable conduit diameters. Additionally, at least one inlet 30 may be disposed circumferentially around the open end 26 for receiving a drawstring 32. The drawstring 32 may be routed through the inlet 30 either externally or internally and may be used to cinch the end 26 tightly around the pipe. FIG. 2B illustrates an optional configuration in which the drawstring 32 may be secured using at least one cord lock 34, allowing for mechanical retention and preventing loosening due to vibration or movement.

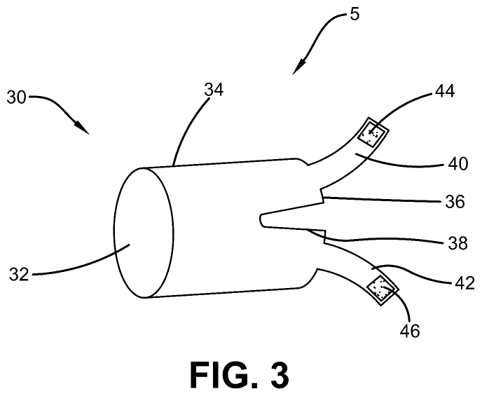

In FIG. 3, a third embodiment 30 is depicted. This embodiment 30 comprises a body 34 and a top 32, forming a generally cylindrical cover similar in geometry to prior embodiments. The material of this embodiment 30 may again include flexible, reinforced textiles, such as but not limited to Nylon, canvas, or rubber-laminated fabric. The end 36 includes at least one slit 38 for expansion and may further incorporate a dual-strap system comprising straps 40,42. The first strap 40 may be equipped with a first fastener 44, and the second strap 42 may include a complementary and reciprocating fastener 46. The fasteners 44,46 may be operably coupled when the straps 40,42 are tightened and connected to one another, ensuring that the device 5 remains securely attached under vibration, movement, or external mechanical stresses. This arrangement allows for precise tension control and efficient reusability across installation cycles. The fasteners 44,46 may include, but are not limited to, hook-and-loop closures, cam buckles, side-release clips, etc.

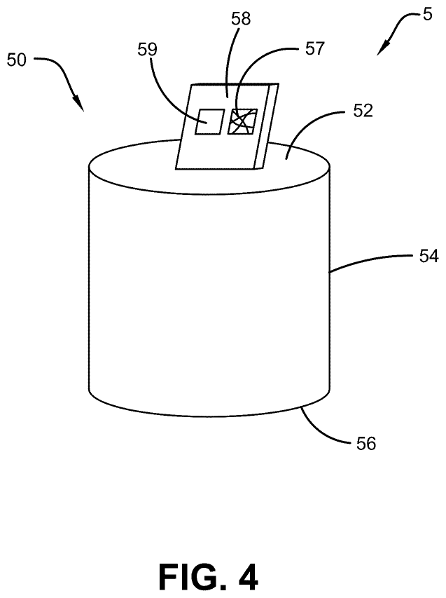

FIG. 4 illustrates a fourth embodiment 50, comprising a body 54, a generally circular top 52, and an open end 56. The cap 50 further includes at least one tab 58 connected to the top 52. The tab 58 may be integrally molded or stitched, depending on the material, and may serve dual functions regarding identification and handling. The tab 58 may be comprised of at least one indicia 59, which may include alphanumeric labels, icons, utility codes, and/or color markings. These features 59 facilitate immediate identification of the pipe's function, enhancing safety and installation efficiency. The tab 58 may also function as a tactile grip to ease removal, wherein the tab 58 is comprised of at least one grip texture 57 that may be raised and/or recessed.

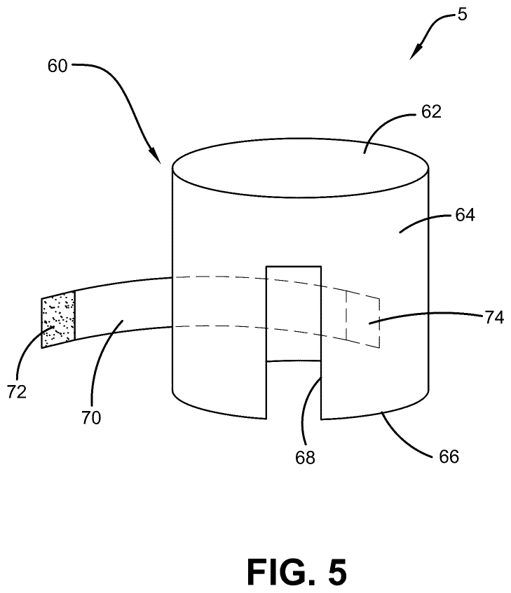

As shown in FIG. 5, a fifth embodiment 60 is presented comprising a body 64, a top 62, and an open end 66. The materials used may include Neoprene, silicone, flexible PVC, vinyl-laminated fabric, etc., or other elastomeric materials that offer durability and flexibility. The end 66 may include at least one radial slit 68 to enable circumferential expansion or contraction, thereby adapting to conduits or piping of varied outer diameters. Additionally, a strap 70 may be affixed to the body 64 near the open end 66. The strap 70 may be configured to encircle the body 64 and the underlying conduit, providing a compressive retention force when fastened.

The strap 70 may be secured using at least one fastener system comprising a first fastener 72 located on the strap 70 itself and a second fastener 74 located on the exterior surface of the body 64. This positioning allows the strap 70 to be wrapped around and then engaged with the body 64 via the complementary fasteners 72, 74, which may include such as but are not limited to, hook-and-loop types, snap fits, press studs, ladder-lock buckles, etc. This configuration ensures robust retention and enables quick release without tools, even in low-visibility or gloved-hand conditions.

All versions of the device 5 may have a body 14, 24, 34, 54, 64, that is color-coded with a color to align with standardized utility markings, such as but not limited to red for electrical, blue for potable water, green for natural gas, yellow for telecommunications, among others. These colorations may be achieved through pigmentation of the body 14, 24, 34, 54, 64 material, overprinting, woven thread integration, or applied coatings, etc.

Furthermore, the device 5 may be manufactured in a variety of standard sizes to accommodate commonly encountered conduit outer diameters. An internal diameter of the device 5 that is slightly undersized in its relaxed state relative to the conduit diameter is preferable, thereby ensuring a secure fit. Example internal diameters may include but are not limited to ½″, ¾″, and 1″ EMT conduit sizes. Dimensional flexibility may be maintained across all embodiments to allow broad applicability across utility installation contexts.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “pipe end cover device” and “device” are interchangeable and refer to the pipe end cover device 100 of the present invention.

Notwithstanding the foregoing, the pipe end cover device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the pipe end cover device 100 as shown in the FIGS. are for illustrative purposes only, and that many other sizes and shapes of the pipe end cover device 100 are well within the scope of the present disclosure. Although the dimensions of the pipe end cover device 100 are important design parameters for user convenience, the pipe end cover device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pipe end cover device comprising:
a flexible body having a top and an open lower end;
wherein the top is closed and the open lower end is dimensioned to stretch over an exposed end of a conduit or a piping;
wherein the body is color-coded with a color to align with a standardized utility color.

2. The pipe end cover device of claim 1, wherein the body is comprised of a tab.

3. The pipe end cover device of claim 1, wherein the tab is comprised of an indicia.

4. The pipe end cover device of claim 1, wherein the indicia is comprised of an alphanumeric label, an icon, a utility code, or a color marking.

5. The pipe end cover device of claim 1, wherein the tab is comprised of a grip texture.

6. A pipe end cover device comprising:
a body having a top and an open end, the body being formed of a textile material;
a longitudinal slit disposed at the open end that permits radial expansion or contraction of the body;
a drawstring.

7. The pipe end cover device of claim 6, wherein the drawstring is comprised of a cord lock.

8. The pipe end cover device of claim 6, wherein the body is comprised of an inlet.

9. The pipe end cover device of claim 8, wherein the inlet receives the drawstring.

10. The pipe end cover device of claim 8, wherein the body is comprised of a water-resistant coating.

11. The pipe end cover device of claim 8, wherein the body is comprised of a flame-resistant coating.

12. The pipe end cover device of claim 6, wherein the body is color-coded with a color to align with a standardized utility color.

13. A pipe end cover device comprising:
a body having a top and an open end;
a strap affixed near the open end, the strap being configured to encircle the body and a conduit or a piping; and
wherein the strap comprises a first fastener and the body comprises a second fastener to enable engagement between the strap and the body.

14. The pipe end cover device of claim 13, wherein the first fastener is comprised of a hook fastener.

15. The pipe end cover device of claim 13, wherein the first fastener is comprised of a loop fastener.

16. The pipe end cover device of claim 13, wherein the body is comprised of a flexible material.

17. The pipe end cover device of claim 13, wherein the body is color-coded with a color to align with a standardized utility color.

18. The pipe end cover device of claim 17, wherein the color is comprised of a red for electrical.

19. The pipe end cover device of claim 17, wherein the color is comprised of a blue for a potable water.

20. The pipe end cover device of claim 17, wherein the color is comprised of a green for natural gas or a yellow for electrical.
